(19) United States
(12) Patent Application Publication
(10) Pub. No.: US 2002/0113677 A1
(43) Pub. Date: Aug. 22, 2002

(54) Variable bleed solenoid

(76) Inventors: Garrett Holmes, Ortonville, MI (US); Jeffrey J. Waterstredt, Royal Oak, MI (US)

Correspondence Address: Patent Docket Administrator, BorgWarner Inc., 3001 West Big Beaver Rd. - Suite 200, P.O. Box 5060, Troy, MI, 48007-5060, US

(21) Appl. No.: 10/034,826

(22) Filed: Dec. 28, 2001

Related U.S. Application Data
(60) Provisional application No. 60/258,901, filed on Dec. 28, 2000.

(51) Int. Cl. H01F 3/00

(52) U.S. Cl. 335/256

(57) ABSTRACT

A low leak variable bleed solenoid. The solenoid can be configured in either a proportional or inversely proportional configuration by interchanging parts of the solenoid. The solenoid includes a valve manifold for metering flow from supply to exhaust. The valve manifold includes a first valve seat and a second valve seat for selectively sealing of hydraulic supply side pressure and control side pressure.

### TECHNICAL FIELD

The present invention relates to a solenoid valve for use in hydraulic controls. More specifically, the present invention relates to a low leakage variable bleed solenoid for use in an automatic transmission control system.

### BACKGROUND OF THE INVENTION

Solenoids are used for control of hydraulic circuits in the control systems of a transmission. In the past, typically, these valves provide control to the transmission and are actuatable for variable flows to control circuits in the transmission. In the past, typically, it has only been necessary to actuate the solenoids upon control input and in the relaxed state leakage is common among solenoid control valves in use today. However, in today's vehicles, any power savings which can be found are desirable. Thus, it has been desirable to provide a low leakage type solenoid which may be useful in control of hydraulic systems in automatic transmissions or the like. Additionally desirable is a simple solenoid in which parts are interchangeable for the proportional and inversely proportional solenoids which are desirable in use in vehicles today. The combination of proportional and inversely proportional solenoids is common in vehicles to provide certain limp home conditions on the loss of electrical power to the transmission. Thus, it is desirable to provide a solenoid having single parts which are interchangeable in configurations from either proportional or inversely proportional solenoids, thus reducing costs in the vehicle application.

A low leak solenoid will provide savings in terms of the size of hydraulic pump needed to run the hydraulics in the transmission, thus saving overall power in the power train and resulting in better fuel economy and better performance.

### SUMMARY OF THE INVENTION

Thus, in accordance with the present invention there is provided a variable bleed solenoid which has low leak properties. The variable leak solenoid of the present invention includes a housing defining an internal chamber therein. An electromagnetic coil is wound on a bobbin and the bobbin is coaxially mounted within the housing. An axially movable armature is mounted in the internal chamber. The armature has a first end and a second end. An actuation member extends from an end of the armature. A pole piece is disposed about the armature for moving the armature in a first direction upon energizing of the coil. A valve manifold is provided which includes an aperture for a hydraulic supply pressure and a chamber leading to hydraulic control side pressure. The valve manifold also has a means for exhausting the control side pressure. The valve manifold includes a first valve seat and a second valve seat. The first valve seat and second valve seat provide one valve seat for selectively sealing off the hydraulic supply pressure and the second valve seat for sealing off the control side pressure. A spring is provided for biasing the armature. A control valve for allowing control of the supply pressure in the supply side for sealing the supply side pressure in a low leak position.

A further understanding of the present invention will be had in view of the description of the drawings and detailed description of the invention, when viewed in conjunction with the subjoined claims.

### BRIEF DESCRIPTION OF THE DRAWINGS

FIG. 1 is a sectional view of a proportional variable bleed solenoid of the present invention;

FIG. 2 is a sectional view of an inversely proportional variable bleed solenoid valve of the present invention; and

FIGS. 3a-3d are graphical representations of typical performance curves of the solenoid valves of FIGS. 1 and 2.

### DETAILED DESCRIPTION OF THE PREFERRED EMBODIMENTS

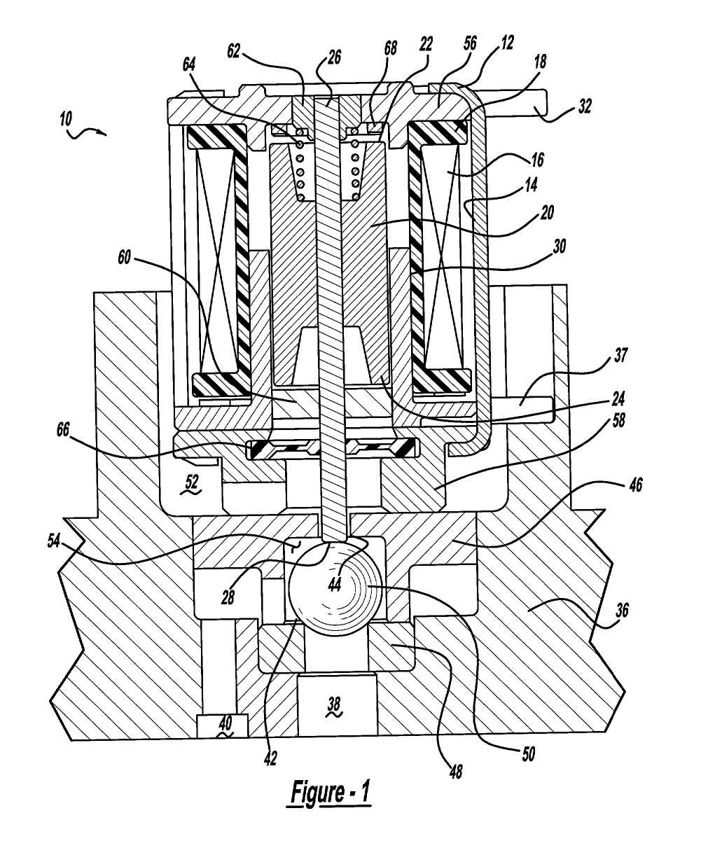

Thus in accordance with the present invention there is provided a variable bleed solenoid 10, which is inversely proportional. As will be readily appreciated to those skilled in the art, the present invention also includes a companion proportional solenoid 10a, as shown in FIG. 1. The use of pairs of solenoids such as that shown are preferable for providing limp home characteristics upon any loss of electrical power characteristics. Like parts in the drawings are shown by like numerals, whereas the differences between the drawings will be referenced in the subscript “a”.

The variable bleed solenoid 10 includes a housing 12 defining an interior chamber therein 14. An electromagnetic coil 16 is wound around bobbin 18. The bobbin 18 is coaxially mounted within the housing 12. An axially movable armature 20 is configured inside the bobbin 18. The armature 20 includes a first end 22 and a second end 24. An actuation member 26 extends from the armature 20 and has actuation end 28. Preferably, the actuation member 26 is a guide pin which is press fit for securing inside the armature 20. Thus, the actuation member 26 moves with movement of the armature 20. A flux tube 30 or 30a and associated pole piece 56 or 56a is disposed about the armature 20 for providing movement of the armature in a first direction upon energizing of the coil 16. The coil 16 is connected to terminals 32 and 34 for energizing the coil.

A valve manifold is provided and generally shown at 36. Valve manifold 36 includes a passage 38 for supply side hydraulic pressure and a passage 40 for control side hydraulic pressure. A first valve seat 42 and a second valve seat 44 are provided by press fit inserts 46 and 48. The manifold 36 is an assembly with press fit pieces 48 and 46, and includes a valve 50, typically a ball valve, which may be interposed on either of the valve seats for control of control side pressure and exhaust to sump, which allows variable control pressure input. The exhaust circuit is provided for exhausting to chamber 52 through valve seat 44. A ball cage portion 54 entraps the ball between the axially aligned valve seats 44 and 42. Thus, when the ball member 50 is seated on valve seat 42, the supply side hydraulic pressure 38 is cut off and when seated on valve seat 44, the exhaust side is cut off.

A pole piece 56 and 56a is provided along with solenoid sleeve 58. The actuation rod 26 is slidingly secured between bushings 60 and 62. Additionally, a rubber or polymer diaphragm 66 keeps fluid and suspended contamination from entering the chamber of the armature. Also, a non-metallic air gap spacer 68 is provided in the construction, as is conventional in solenoid construction. Spacer 68, along with bushings 60 and 62 are made of a non-magnetic material such as brass or the like.

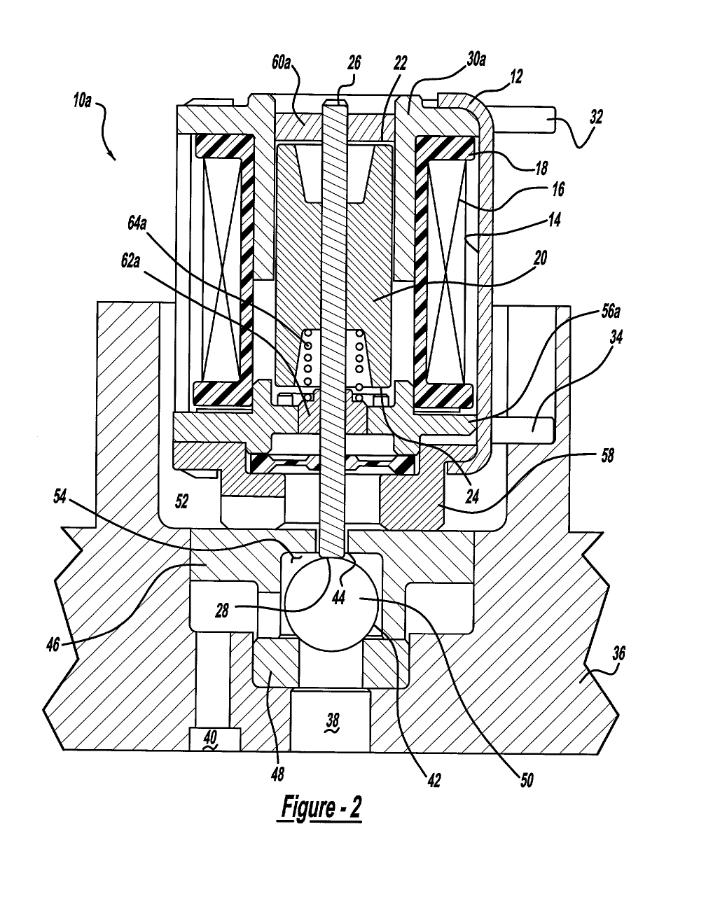

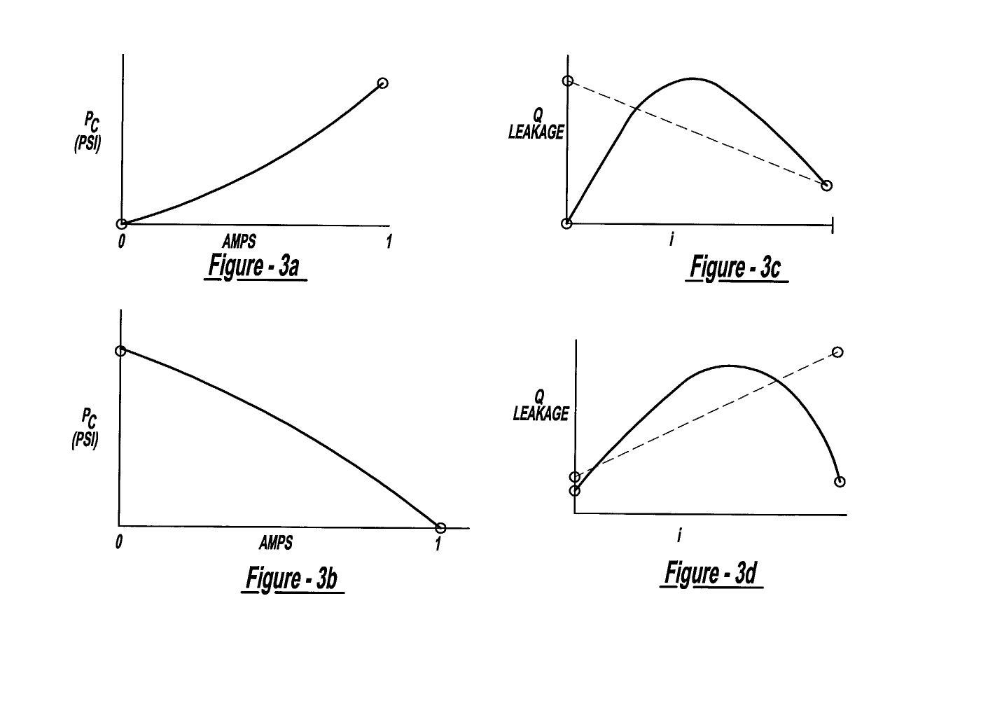

As will be readily appreciated, the solenoid 10 of FIG. 1 differs from the solenoid 10a of FIG. 2, in that one is a proportional solenoid and the other inversely proportional. Specifically, the solenoid 10a is inversely proportional and solenoid 10 proportional. As will be readily appreciated, the pieces of these solenoids are interchangeable such that either proportional or inversely proportion solenoids may be manufactured of the same pieces. The difference being that the pole piece and flux tubes are interposed in opposite directions between the members, along with associated fittings 60a, 62a. Additionally, the spring used is different in the two solenoids. In the solenoid 10 of FIG. 1, the spring is designed such that the spring overcomes the supply pressure acting on the valve 50 in the static state, i.e., without any current flowing through the terminals. Thus, solenoid 10 is normally closed. In order to allow supply pressure to bleed, the core is energized, which draws the armature away from the ball valve 50, allowing flow from the supply chamber 38 to the control side chamber 40 and reducing exhaust flow to the sump 52. Thus, upon receipt of actuation current through the terminals, the armature compresses the spring and allows supply pressure to bleed to control pressure, and reduces the amount of exhaust to sump, up until the point that the exhaust is substantially eliminated. Thus, as shown in the curve of FIG. 3a, the control pressure rises as the current is raised from zero amps to about 1 amp, and increases along the curve. As set forth in FIG. 3c, the leakage starts at substantially no leakage and ends at close to low leakage, which is in contradistinction to normal solenoids used today, as shown in the dashed line. While zero to 1 amps voltage may typically be used, it is to be appreciated that larger ranges or smaller ranges may be utilized depending on the application.

With respect to the solenoid in FIG. 2, in the solenoid of FIG. 2, the spring is configured with just enough pressure to allow high control side pressure under no current conditions with low leakage. Upon actuation, the ball 50 is forced into valve seat 42, resulting in low leakage conditions upon actuation. This is shown in the second set of curves, FIGS. 3b and 3d, whereas the dashed line indicates leakage conditions for prior solenoids. The spring can either be positioned as shown for holding open the valve or be placed in the position of FIG. 1 but using a spring which would not overcome supply side pressure resulting in a normally open position.

Thus, in the present situation, solenoids are provided which have interchangeable parts, for either providing a proportional or inversely proportional solenoid, and the solenoids act to have low leakage characteristics, as set forth above. This results in reduced pump capacities and resultant energy savings.

Those skilled in the art can now appreciate from the foregoing description that the broad teachings of the present invention can be implemented in a variety of forms. Therefore, while this invention has been described in connection with particular examples thereof, the true scope of the invention should not be so limited, since other modifications will become apparent to the skilled practitioner upon a study of the drawings, specification and following claims.

1. A variable bleed solenoid which has low leak properties comprising:
a housing defining an internal chamber therein;
an electromagnetic coil wound on a bobbin wherein said bobbin is coaxially mounted within the housing;
an axially movable armature mounted in the internal chamber, said armature having a first end and a second end;
an actuation member extending from an end of said armature;
a pole piece and flux tube operably associated with said armature for moving said armature in a first direction upon energizing said coil;
a valve manifold including a passage for a hydraulic supply pressure and a chamber leading to a hydraulic control side pressure and for directing said control side to an exhaust;
a first valve seat and a second valve seat;
a valve positioned for selectively sealing on said first valve seat or said second valve seat;
a spring for biasing said armature; and
a control circuit for supplying power to said armature for allowing control of said supply pressure in a supply side for sealing the valve in a low leak position.

2. The solenoid of claim 1 wherein:
said spring biases said valve in a first direction and overcomes supply pressure acting on the valve, said armature upon being energized overcoming said spring and selectively opening said valve for allowing supply side pressure to bleed to the control side pressure port.

3. The solenoid of claim 2 wherein said manifold further comprises a supply side seat and an exhaust side seat with said valve moving between said supply side seat and said exhaust side seat for selectively and variably positioning therebetween.

4. The solenoid of claim 3 wherein the valve is a ball positioned between said exhaust side seat and said supply side seat.

5. The solenoid of claim 4 wherein the valve seats are axially aligned with said actuation member.

6. The solenoid of claim 1 wherein the armature acts to close the valve upon actuation thereof, said valve being normally open to supply side pressure.

7. The solenoid valve of claim 6 wherein said spring is weaker than said supply side pressure acting on said valve.

8. The solenoid of claim 7 wherein said valve is a ball valve.

9. A variable bleed solenoid which has low leak properties comprising:
a housing defining an internal chamber therein;
an electromagnetic coil wound on a bobbin, wherein said bobbin is coaxially mounted within the housing;
an axially movable armature mounted in the internal chamber, said armature having a first end and a second end;
an actuation member extending from an end of said armature;
a pole piece and flux tube operably associated with said armature for moving said armature in a first direction upon energizing said coil;
a valve manifold including an aperture for a hydraulic supply pressure and a chamber leading to a hydraulic control side pressure port;
a first valve seat and a second valve seat;
a valve positioned for selectively sealing off said passages; and
a spring for biasing said armature toward closure of said valve to said supply side pressure, said spring being strong enough to overcome the supply pressure acting against it and said armature overcoming said spring biasing when said coil is energized.

10. The solenoid of claim 9 wherein the manifold further comprises a supply side seat and an exhaust side seat with said valve moving between said supply side seat and said exhaust side seat and to variable positions therebetween.

11. The solenoid of claim 10 wherein the valve is a ball positioned between said supply side seat and said exhaust side seat.

12. The solenoid of claim 9 wherein the armature is axially aligned with said actuation member.

13. A variable bleed solenoid which has low leak properties comprising:
a housing defining an internal chamber therein;
an electromagnetic coil wound on a bobbin wherein said bobbin is coaxially mounted within the housing;
an axially movable armature mounted in the internal chamber, said armature having a first end and a second end;
an actuation member extending from an end of said armature;
a pole piece and flux tube operably associated with said armature for moving said armature in a first direction upon energizing said coil;
a valve manifold including an a passage for a hydraulic supply pressure and a chamber leading to a hydraulic control side pressure and for directing said control side to an exhaust;
a first valve seat and a second valve seat;
a valve positioned for selectively sealing on said first valve seat or said second valve seat;
a spring for biasing said armature; and
a control circuit for supplying power to said armature for allowing control of said supply pressure in a supply side for sealing the valve in a low leak position;
wherein said solenoid may be configured into either a first proportional or inversely proportional configuration by inverting of the pole piece and flux tube in the housing and replacement of said spring.

14. The solenoid of claim 13 wherein in the proportional configuration the spring biases the valve in a first direction for overcoming supply pressure acting on the valve and said armature upon being energized overcomes the spring and opens the valve for allowing supply side pressure to bleed to the control side pressure port.

15. The solenoid of claim 13 wherein in the inversely proportional configuration said supply side pressure is normally open to control side pressure and said armature closing said valve upon energizing of said coil.

16. The solenoid of claim 15 wherein a spring is utilized that is weaker than the force of said supply side pressure acting on the valve for allowing the normally open condition.

17. The solenoid of claim 15 wherein a spring is configured for moving the armature toward opening of the valve to control side pressure.

18. The solenoid of claim 13 wherein said valve is a ball valve.

19. The solenoid of claim 14 wherein said valve is a ball valve.

20. The solenoid of claim 15 wherein said valve is a ball valve.

21. The solenoid of claim 16 wherein said valve is a ball valve.

22. The solenoid of claim 17 wherein said valve is a ball valve.
